(19) United States
(12) Patent Application Publication
(10) Pub. No.: US 2023/0155835 A1
(43) Pub. Date: May 18, 2023

(54) SYSTEM, METHOD, APPARATUS, AND COMPUTER PROGRAM PRODUCT PROVIDING IMPROVED PASSWORD SECURITY

(71) Applicant: Charles Stephen Edge, Minneapolis, MN (US)

(72) Inventor: Charles Stephen Edge, Minneapolis, MN (US)

(21) Appl. No.: 18/048,116

(22) Filed: Oct. 20, 2022

Related U.S. Application Data
(60) Provisional application No. 63/280,460, filed on Nov. 17, 2021.

(51) Int. Cl. H04L 9/32; H04L 9/08; H04L 9/30

(52) U.S. Cl. CPC H04L 9/3231; H04L 9/0825; H04L 9/3066

(57) ABSTRACT

A system, apparatus, method, and computer program product for generating and using stored shards of passwords on multiple native biometric sensors is disclosed. This invention takes each password, encrypts the password using a key from a biometric sensor, converts the encrypted key, and splits it into a user-definable number of parts, or shards. Shards can then distribute to multiple devices and then only unlock the password (or other form of a secret) if many shards are present. The invention changes a password manager from a potential security threat to a convenience.

### CROSS-REFERENCE TO RELATED APPLICATION

This application claims the benefit of priority of U.S. provisional application No. 63/280,460 filed Nov. 17, 2021, the contents of which are herein incorporated by reference.

### BACKGROUND OF THE INVENTION

The present invention relates to data security, and more particularly to data security involving biometric sensors.

Biometric sensors generate encryption keys but do not encrypt data, thus leaving the threat of a password to unlock password managers and use those keys. The password or encryption key is stored with conventional password managers. Therefore, when an entire password is stored in an encrypted database, like a modern password manager does, the password managers can be susceptible to brute force attacks.

Conventional security processes store all of a user's passwords and/or encryptions keys in a password manager (e.g. Apple Keychain, Microsoft Vault, and a variety of third party password managers). Most password managers are small SQLite or similar databases. If the password manager is compromised then all the user's passwords, private keys, and tokens can then be decrypted and used. Other devices and systems—notably software—that previously existed were not considering the full ecosystem of threats but instead focused on one app and one password thus leaving a flaw in how we obtain assets to our passwords.

Further, existing encryption schemes rely on a public and private key pair to gate access to secrets at rest on devices. These rely on the infeasibility of an attacker to gain access to the other of the keys if they only have one. Key lengths increase with processor speeds at a rate that corresponds to Moore's Law. However, there are asymmetrical ways to approach decryption of these assets, be it brute force on a large scale. For example, a nation state could treat all devices in their space as a grid of computers to attempt to decrypt, or multiple quantum computers (e.g., at a university system) using previously unpredictable algorithms to break codes are used. This is made possible by the fact that all objects required to gain access to secrets (e.g., passcodes, FIDO tokens, passwords, etc.) are on a single device.

As can be seen, there is a need for improved systems, apparatus, methods, and computer program products to provide improved password managers that are not susceptible to the foregoing security threats.

### SUMMARY OF THE INVENTION

In one aspect of the present invention, the present invention breaking apart each secret in a way that the shards of the secret can be securely stored on multiple devices. We do so with the possibility, but not requirement, to recover keys via an escrow service.

In another aspect of the present invention, a method for multi-factor authentication of a secret via a decryption application, using a plurality of terminals, each terminal comprising at least one unique biometric sensor and operatively associated with the decryption application, the method includes the following: sharding the secret into a plurality of shards; receiving, at each terminal, a unique shard of the plurality of shards; and encrypting each unique shard with a biometric key of the at least one unique biometric sensor of the receiving terminal, wherein the decryption application requires for decryption of the secret both a presence of two or more shards of the plurality of shards and separate accessibility of the biometric key associated with each of the two or more shards.

In yet another aspect of the present invention, the method for multi-factor authentication of a secret via a decryption application, using a plurality of terminals, further includes encrypting the secret, prior to sharding, with an elliptical curve key (ECK), wherein the secret is an alphanumeric string; integer-initializing the alphanumeric string, wherein a pool of potential shards of the plurality of shards are generated, wherein K is a threshold with which no less than K-1 shards of the plurality of shares defines a parity amount of two or more shards, wherein each of the plurality of shards are received by an escrow service hosted as a web server, for only when an associated terminal is inaccessible; and further including transferring a shard map to each terminal that receives one shard of the plurality of shards, wherein the shard map defines an expected parity of the plurality of shards, wherein the shard map comprises a collection of generated unique identifiers (GUID) for the secret for each terminal that receives one of the plurality of shards, and wherein each terminal is a remote endpoint terminal, wherein each of the two or more shards decrypted via biometric authentication of the associated biometric key is inert until each of the two or more shards are decrypted via biometric authentication, and wherein the decryption application reassembles the two or more shards only after each of the two or more shards is decrypted via biometric authentication.

These and other features, aspects and advantages of the present invention will become better understood with reference to the following drawings, description and claims.

### BRIEF DESCRIPTION OF THE DRAWINGS

FIG. 1: is a flow chart of the invention, showing steps to produce shards of the stored key (whether a public or private key) of an elliptical curve key issued by an operating system on behalf of a secured chip (e.g. Apple T2 or Intel TPM chips).

FIG. 2: is an example of how the password results in a key that can then be split into an arbitrary number of shards and how those might be distributed.

FIG. 3: is an example of how the cryptographic processes can be simplified in such a way that they are simple for end users.

FIG. 4: is a schematic view of the invention with details on how metadata acquired during the cryptographic operations can be displayed to users.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, apparatus, and computer program product that provides improved credential (keys, passwords, etc.) security while those credentials are at rest on a device. The present invention takes each password, encrypts the password using a key with a key derived from a biometric sensor, converts the encrypted key into a big integer, and splits that integer into a user-definable number of parts, or shards. The shards can then be distributed to multiple devices and then only unlock the password (or other form of a secret) if a minimum number of specified shards are present. Further, as each device has a unique biometric sensor, the shards are encrypted with the biometric key from each and a new set of shards created so the password or other credential can be unlocked on those devices. Thus a password manager doesn't present a greater security threat, and is transformed into a convenience.

Chips that host secrets, FIDO keys, and other forms of biometric or key-based encryption do not allow user-generated content in the store of keys. Instead, they generate private keys and present Application Programming Interfaces (API)s, or userland processes those users can communicate with. This leaves credentials exposed to brute force attacks at rest on devices. By encrypting a password or token using the key from a biometric sensor and then splitting that encrypted asset into parts (which we call shards). Those shards can then be used to decrypt the credential only if 2 or more (where 2 is a user definable integer) shards are present and the biometric key is accessible (e.g. by presenting a fingerprint, retinal, or face scan that unlocks the key).

Each shard can then be stored in a password manager with an option to escrow shards onto a web service for retrieval in the event that a shard is lost. The user has the option not to use the web service and can in fact choose to have all shards be required to unlock a given secret. For example, an Apple Watch, a Mac, and an iPhone can all be required to be online and unlocked with a biometric or PIN to unlock three shards where three shards are required to access a credential. If fewer than K-1 shards per diagram 1 are required, then remaining shards have enough parity information to be able to unlock a secret provided the required shards are present.

It is desirable to avoid having personally identifiable information available to any devices that do not have enough shards to access information. Therefore, a shard map, in the form of a Json document, is transferred to each device that stores a shard. That shard map only contains a collection of generated unique identifiers (or GUIDs) for each secret and an array of other GUIDs that are required to decrypt the secret, as well as device GUIDs for which device hosts each shard.

Password managers are susceptible to brute force attacks. Also, password managers typically do not require users to update their credentials to the password manager. For example, a user who has been forced to change their login window password for Windows or a Mac might not have changed their Microsoft Vault or Keychain password for years (and across multiple computers). This makes the password manager itself a potential security threat. Therefore, the present invention does not store an entire password in an encrypted database, as is the practice in modern password managers. Instead, the present invention requires access to at least two forms of biometric sensors and only unlocks a password if two or more shards of a password have enough parity information that matches what is expected in the shard map.

While existing password managers can use a biometric sensor to unlock a password, the present paradigm can also use a key. Keys include Json Web Tokens (JWTs), Bearer Tokens, OAuth2 tokens/cookies used for single sign-on, and other forms of token-based authentication. Therefore there are, at minimum, two vectors to brute force a password or key that can be used to unlock a secret on multiple devices. This reduces the potential time to gain access via a brute force attack to one half. Further, many of those objects are exportable. The present invention thus retains the paradigm where a public key infrastructure (PKI) is utilized to issue public and private keys that have passwords which can be used to override or access the keys. The current invention does so with an additional layer of security that shards that information multiple times and reassembles the shards. For the end user, the process is as simple as being prompted to present a biometric authentication on one or more user devices, where the only limit is how many devices a user has and how many could still be used in a performant manner. The biometric authentication may be one or more of a facial recognition, a fingerprint, a retina scan, and the like, on a mobile device or when clicking into a password field on a laptop (or vice versa).

A method according to aspects of the invention accomplishes this by taking multiple pieces of data and splitting the information up as shards, rather than just distributing data that is reversible and subject to a brute force attack, such as conventional PKI processes (e.g., a public key with enough attempts can be used to regenerate a private key in PKI). Each shard could be brute forced; however, an attacker would need to brute force multiple shards and would have no way of knowing whether the shards are useable unless doing so with multiple shards concurrently (akin to pre-bombe attempts to break Enigma encryption). Thus, the present invention employs encryption techniques based on biometric information and then splits up keys as shards and distributes those shards to different locations, allowing for a multi-factor authentication that is quantum-proof.

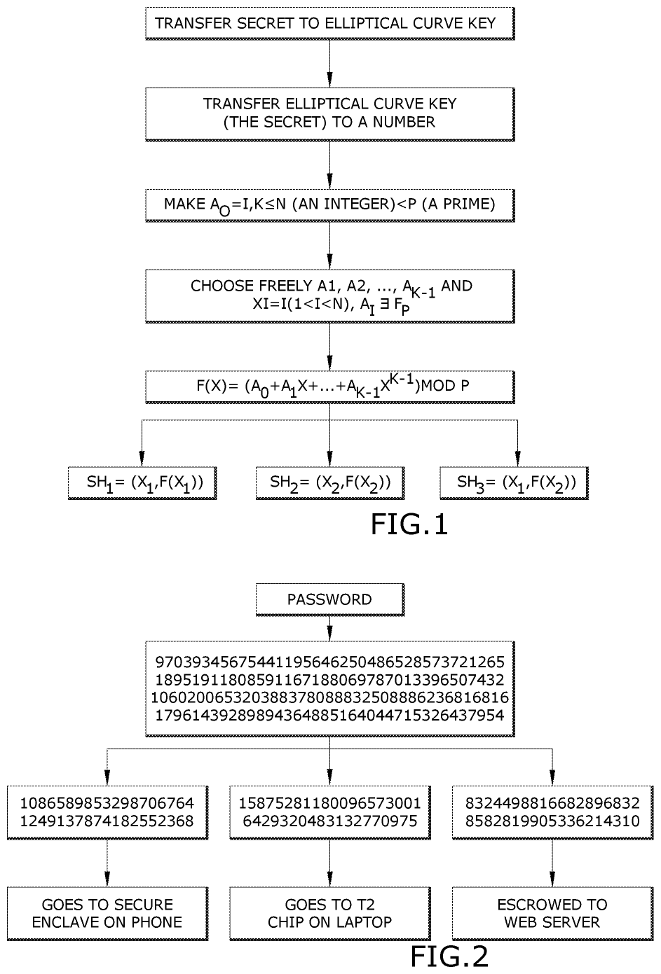

As seen in reference to FIG. 1, the initial processing of the secret is made possible by using an iterative extended Euclidean algorithm to determine the greatest common divisor (gcd) of multiple integers, that have a multiplicative inverse modulo, which we call shards. This initial processing is based on the work of Adi Shamir in his secret sharing scheme from his 1979 paper delivered to Association of Computing Machinery entitled “How to share a secret.”

In the non-limiting embodiment shown in FIG. 1, the “secret”, which may be an alphanumeric string, is transferred to an encryption scheme utilized by the biometric authentication routine (as exposed via an API) of the mobile computing device and one or more other computing devices selected by the user for providing the multi-factor authentication. For example, in the case of an iOS or a macOS device manufactured by Apple™, of Cupertino, Calif., the encryption scheme utilizes an elliptical curve key (ECK). The same forms of keys are issued via FIDO2-compliant devices as well as the Intel TPM chip but may change in the future. The cipher employed is irrelevant, so the invention would still be the same with distinct types of keys and can be used interchangeably with other encryption algorithms such as AES. Triple DES, Blowfish, Twofish, RSA, etc. Once a key is provided, the secret (password, token, or key) is encrypted via a native or app-based API and stored in the form of an ECC key, which generates a numeric representation of the secret, or the elliptical curve key, which is then converted into an integer, represented in FIG. 1 as A₀.

The sharding process then employs a modified Lagrange interpolation theorem akin to the Shamir Scret Sharing scheme documented in Shamir, Adi (1979), “How to share a secret”, Communications of the ACM, 22 (11): 612-613, doi:10.1145/359168.359176, S2CID 16321225. defines the points on an elliptical curve for each shard that may be created from the elliptical curve key, A₀., defining an order and a sequence of the shards.

A method according to aspects of the present invention may include the following process steps:

1. Encrypting a password using an elliptical curve key (ECK) derived from a biometric sensor, based on an API from a given vendor of the biometric sensor (e.g., CoreCrypto from Apple, TPM Base Services from Microsoft, the FIDO2 SDK, etc.). This secret is then split into n shards, which may be called as method(Secret,n).

2. Converting an object encrypted into an alphanumeric string into an integer, known as integer initialization, which we can convert a string into an Int type. Further, if the existing string requires it, as is the case with most strongly typed programming languages, use a nil coalescing to further define the initialized integer returned. This produces the element of a finite field larger than the number of shards generated, each as an SH. That finite field is A₀.

3. Generating a 12th Mersenne Prime number, or a prime number that is one less than a power of two. These are generated via the Sieve of Eratosthenes, known since the 3^{rd} century BCE. For this use, the prime number should be representative of the security level, so large enough to handle the appropriate ciphertext, so to the power of 2281 or greater.

4. Evaluating a polynomial (the coefficient tuple) to generate a pool of potential shards, or points on a finite field. K (FIG. 1) is a threshold with which no less than k-1 shards (SH) can be used to decrypt the encrypted secret.

5. Dividing integers from modulus to find the inverse of the denominator modulo. Evaluate the prime polynomial, or coefficient tuple) to make sure the minimum shards are possible.

6. Multiplying the numerator of a modulus by the inverted modulo (p). This is done via s standard modular multiplicative inverse functions via an extended Euclidean algorithm.

7. Determining the y-value for the given x, given n (x, y) points are a polynomial of up to kth order, Multiply the numerator by the inverse

8. Calculating the product of inputs and avoid inexact division for a cyclic check of recoverability.

9. Tracking of an index number so the shards can be recombined. The index number is stored as the shard data, along with a GUID of the shard, and a GUID of the device that held the shard.

In preparing the shards, the user may be prompted for the number of shards, (A₁-Aₓ) to be created, and a minimum number of shards, XI, necessary to reconstruct, or provide an authentication of the secret.

With the user inputs, the elliptical curve key of the secret is broken into its shards, based on the selected number of shards, A1 and the minimum number of shards necessary to reconstruct the secret XI. Each of the respective output shards, SH₁, SH₂, SH₃, etc.

The process of FIG. 1 is summarized in FIG. 2. Once created, the shards may be verified with each other before communication to the respective storage locations of the selected devices for the shards. Once delivered to the target storage devices, the secret in memory will be destroyed and then only available ad hoc if all required devices, with their biometrically derived keys are available. At creation and each subsequent access, the secret will be deleted from memory and is not written to disk in an unencrypted and unsharded form.

Each of the shards are then communicated to a secure storage location associated with the biometric authentication routine of the selected one or more authenticating devices. The shard may be delivered to the one or more authenticating devices via an API for the operating system of the authenticating devices.

By way of non-limiting example, in the case of an iOS biometric authentication, the corresponding shard is stored in keychain as non-exportable and encrypted using the secure enclave associated with the phone or iOS device. In this example, the API may be the Apple COREDATA API. In the case of a laptop computer, the corresponding shard is secured with keys from a T2 chip on the laptop computer, again via an API associated with the OS for the computing system. In an Apple Watch, the corresponding shard is stored in an iCloud Keychain and unlocked with a PIN, provided the watch is active and has not been removed from a wrist.

As previously indicated, a shard may also be retained by an escrow service hosted as a web server, for use in the event one of the user devices is lost, stolen, damaged, or otherwise unavailable for a subsequent authentication session. Further, in the event of a lost device, shards can be exported to such a location or to a secured offline physical storage device.

Because aspects of the present invention contemplate that the devices be available to the user seeking secure authentication, the communication of the shards to the respective devices may be accomplished via a local communication with the device. Accordingly, the communication may be achieved via one or more of the following (in the following order of preference for security purposes): 1 a Bluetooth pairing of devices; 2) a Wi-Fi communication via a common wireless access point on which the devices communicate; 3) a near field communication (NFC) protocol; and 4) a push notification to the selected device.

The present invention employs layers in biometric encryption to further secure the process and make it simpler for humans to use. Once the encryption, sharding, and sharing processes, described above are complete, an app, operating on one or more of the user's mobile computing device, or computing device may be utilized for entering a password or providing a key for a protected service or application where doing so is required.

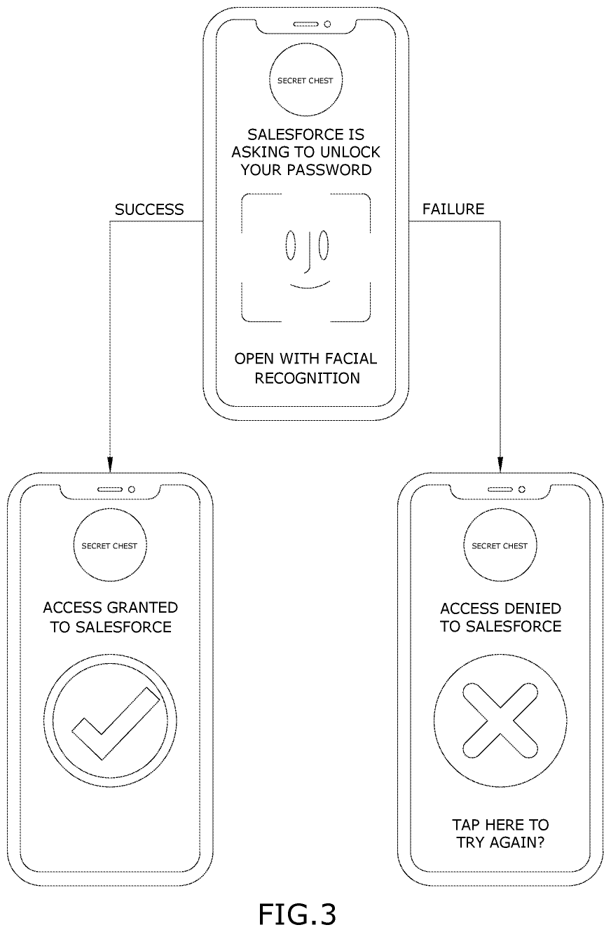

The present invention may be implemented as an application programming interface (API) for a password manager or as a password manager itself. A representative user interface for an embodiment of the authentication of a secret of any kind that is required to access a service, as shown in reference to FIG. 3. In a non-limiting embodiment, where the user has specified two devices for authentication and three shards (out of a potential of dozens), the user will begin the authentication process from a first device, to access a service, such as Salesforce.

The password for the service is entered and authenticated utilizing a first biometric authentication of the user utilizing the first device. If the user succeeds in the first biometric authentication of the first device, the shard itself will be decrypted but is not yet usable. A prompt, such as shown in FIG. 3 may be presented on a second device requesting a second biometric authentication on the second device. If the user is able to present the second biometric authentication via the second device (SUCCESS) then the shard is decrypted and made available into the decrypting client application on the device that began the operation. Shards from the respective first device and the second device will be re-assembled, and the user will be granted access to a service like Salesforce. All operations must occur in a secure runtime (or an encrypted memory space) and therefore the assembled password is never available in memory or on disk as a single string. This prevents shared libraries, stack heaps, etc. from obtaining access to the secret.

Continuing with the example of FIG. 3, if biometric authentication is not available from the second device, (FAILURE), then the user is denied access to the service and any encrypted shards are removed from memory when the atomic operation completes in a failed state. The user may be allowed to retry biometric authentication for a specified number of attempts, for example, up to three times.

In a method to reconstruct passwords in a way that is invisible to the user and yet secure, the following steps may be performed programmatically:

1. Import shards per domain using a generated json document or property lists from found shards with an index for the domain.

2. Sanitizing the data input. Inputs are validated to ensure an arbitrary string cannot be sent to a device that is capable of injecting incorrect information into a given field. This is done using Benaloh's Scheme, so validation of all shards is t-consistent.

3. Deriving the necessary shards. The map of which shards exist on each device is stored in a manner that contains no personally identifiably information and needs to be checked both when shards are distributed and when they are recovered to re-assemble the required secret(s).

4. Reconstructing the necessary shards with the required ECC Keys. Shards are recovered from a trusted storage location (e.g., Apple Keychain) and then decrypted with a key secured by a key provider location on disk (e.g., the Apple Secure Enclave).

5. Reconstructing the secret (password or other key) in an ephemeral storage (e.g., within a hardened binary) from the shards. Once the shards have been obtained from each required device and the device has decrypted the information, the most computationally efficient approach to recover the secret is via polynomial interpretation.

6. Refreshing ephemeral information (e.g., using the Core Data framework) and so verify clearance of all shards from volatile and non-volatile storage on each device once they are provided to the decrypting device.

7. Decrypting the plaintext based on the presence of the appropriate number of shards (n-x) where n is the number of shards initially generated and x is the number of shards/devices required to be present to reconstruct the plaintext along with the necessary keys.

9. Removing all decrypted secrets from the ephemeral storage location.

In the foregoing example, there need to be at least three shards and two devices each with a shard, and an escrowed shard for recovery in case one of the devices is lost. The third shard is escrowed in a file (e.g. a json web document) on an external device or a web service and can be used to deconstruct a password and then perform the sharding process again, thus obtaining a new set of keys and repeating the process.

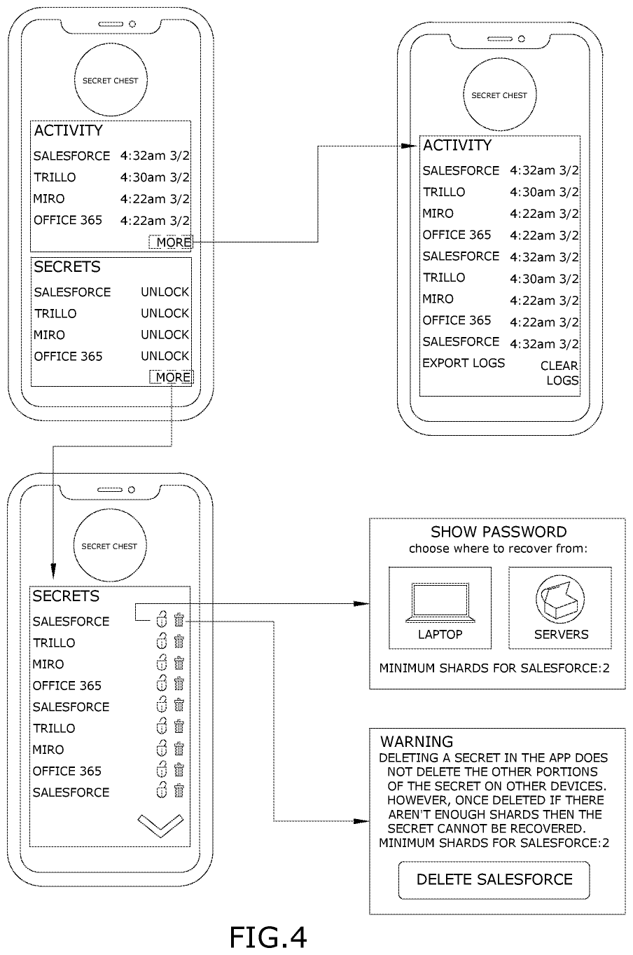

The application may include further enhancements, such as shown in reference to FIG. 4. The application may include an activity log pane and a secrets list pane. The activity log pane may present the most recent authentication attempts by an identifier for the service accessed, and a date time the activity occurred. This information can be used to perform standard anomaly detection using a variety of machine learning techniques to identify improper attempts to authenticate. Similarly, the secrets list pane contains a list of secrets the application has negotiated. The secrets list pane may present the identifier for the most frequently accessed services or a listing of the most recently accessed services. The decrypted information stored should include no more than the generated unique identifiers (GUIDs) and the required information to locate the secret when required. For example, the domain will be required, but not the map, which is itself protected with a standard PKI exchange in a secured location.

Additional control may be provided for accessing a complete activity log of all attempted authentications provided by the app. An export control may be activated to export the activity log for use by an external program. For example, this data can flow or be ingested into a standard security framework such as a SEIM solution. This also allows a user to retain a permanent record of authentication activity. A clear log control may be provided for deleting the contents of the currently stored activity log and enterprise device administrators can block users from clearing the log or institute retention policies.

As with the activity log, the secrets list pane may include a “more” control to display a listing of all secrets retained by the application. A show password control may be activated to show the user the number of user specified shards selected for the service. Activation of the show password may also present the devices and/or locations of the remaining shards to assist the user in completing an authentication process, such as ensuring the user has the correct devices available to complete an authentication process. User controls may also be provided for selecting which source/device the user would like to recover or complete the authentication of the password from. Further, shards can be provided to other users and so used to share credentials or keys on a one-time basis, or this option can be blocked.

The secrets list may also contain a delete control that allows the user to delete a secret for the selected service. Activation of the delete control may present a warning screen alerting the user that deleting a secret from the device may preclude recovery of a secret if the minimum number of shards are not available. The Warning may include a presentation of the minimum shards required for the identified service. In some embodiments, the user may be presented the option to delete the shard from the device they are utilizing. In other embodiments, the user may be presented the option to delete all shards corresponding to the selected service.

The system and methods of the present invention may also be utilized with a workflow for distributing keys, where multiple parties are required to agree on an event. In this example, none of the multiple parties would have access to the full key, yet each providing their own shard in the workflow, once all required shards are accumulated, results in approval of the workflow. Similarly, a smart contract API mechanism could be added to improve programmatic access to objects in blockchain or developer operations (devops) workflows as well. This is done using Feldman's Scheme from 1987 (Feldman, Paul (1987). “A practical scheme for non-interactive verifiable secret sharing”. 28th Annual Symposium on Foundations of Computer Science (SFCS 1987): 427-438. doi:10.1109/SFCS.1987.4. ISBN 0-8186-0807-2. S2CID 16283693.) in place of Benaloh's scheme.

In use, the user enters a secret, which might include a password or a key from an application or website for persistent access. The user has an application loaded on each device that would require the biometric information be distributed to and chooses which to store a shard of the credential on. The user can also have the application generate the secret randomly. The user is then prompted to provide a biometric authentication on two or more devices that generates keys, encrypts objects, and produces shards. These are then distributed to devices and retrieved by clicking a button in a password field and presenting biometric authentication when prompted.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like,

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for multi-factor authentication of a secret via a decryption application, using a plurality of terminals, each terminal comprising at least one unique biometric sensor and operatively associated with the decryption application, the method comprising:
sharding the secret into a plurality of shards;
receiving, at each terminal, a unique shard of the plurality of shards; and
encrypting each unique shard with a biometric key of the at least one unique biometric sensor of the receiving terminal,
wherein the decryption application requires for decryption of the secret both a presence of two or more shards of the plurality of shards and separate accessibility of the biometric key associated with each of the two or more shards.

2. The method of claim 1, further comprising: encrypting the secret, prior to sharding, with an elliptical curve key (ECK), wherein the secret is an alphanumeric string.

3. The method of claim 2, further comprising: integer-initializing the alphanumeric string, wherein a pool of potential shards of the plurality of shards are generated.

4. The method of claim 3, wherein K is a threshold with which no less than K-1 shards of the plurality of shares defines a parity amount of two or more shards.

5. The method of claim 1, wherein each of the plurality of shards are received by an escrow service hosted as a web server, for only when an associated terminal is inaccessible.

6. The method of claim 1, further comprising: transferring a shard map to each terminal that receives one shard of the plurality of shards, wherein the shard map defines an expected parity of the plurality of shards.

7. The method of claim 6, wherein the shard map comprises a collection of generated unique identifiers (GUID) for the secret for each terminal that receives one of the plurality of shards.

8. The method of claim 1, wherein each terminal is a remote endpoint terminal.

9. The method of claim 1, wherein each of the two or more shards decrypted via biometric authentication of the associated biometric key is inert until each of the two or more shards are decrypted via biometric authentication.

10. The method of claim 1, wherein the decryption application reassembles the two or more shards only after each of the two or more shards is decrypted via biometric authentication.
